(19) United States
(12) Patent Application Publication
(10) Pub. No.: US 2025/0343010 A1
(43) Pub. Date: Nov. 6, 2025

(54) CAPACITOR ASSEMBLY HAVING A FIRST TO FOURTH INDIVIDUAL CAPACITOR AND SUPER-ASSEMBLY THEREWITH

(71) Applicant: Semikron Danfoss Elektronik GmbH & Co. KG, Nürnberg (DE)

(72) Inventors: Peter Lemke, Schwabach (DE); Sandro Bulovic, Langenzenn (DE); Johannes Klier, Amberg (DE); Levent Oruc, Nürnberg (DE); Michael Hufnagel, Heilsbronn (DE)

(21) Appl. No.: 19/194,142

(22) Filed: Apr. 30, 2025

(30) Foreign Application Priority Data
May 2, 2024 (DE) 102024112357.5

(51) Int. Cl. H01G 4/38

(52) U.S. Cl. CPC H01G 4/38

(57) ABSTRACT

A capacitor assembly is presented, having a first to fourth individual capacitor each with a first top surface defining a respective normal direction of the individual capacitor and a second top surface opposite said first top surface, wherein the first top surface of the first individual capacitor defines a main direction, in each case first connection elements arranged on the first top surface and in each case second connection elements arranged on the second top surface, wherein the individual capacitors are arranged beside one another in a 2×2 matrix, wherein the normals of the first and second individual capacitor forming a first sub-assembly point in the main direction and wherein the normals of the third and fourth individual capacitor forming a second sub-assembly point opposite the main direction and wherein all the first connection elements are connected to one another by a first busbar and wherein all the second connection elements are connected to one another by a second busbar.

### CROSS-REFERENCE TO RELATED APPLICATION

This application claims foreign priority benefits under 35 U.S.C. § 119 to German Patent Application No. 102024112357.5 filed on May 2, 2024, the content of which is hereby incorporated by reference in its entirety.

### TECHNICAL FIELD

The invention describes a capacitor assembly having a first to fourth individual capacitor, wherein the individual capacitors are preferably arranged beside one another in a 2×2 matrix. The invention furthermore describes a super-assembly made up of two capacitor assemblies.

### BACKGROUND

DE 10 2019 134 650 A1 discloses a power-electronic system with a housing, with a cooling device, with a power semiconductor module and with a capacitor device, wherein a cooling portion of a capacitor connection device is in thermally conductive contact with a cooling surface of the cooling device.

DE 10 2012 215 787 A1 discloses a power-electronic system with a multi-part housing, a plurality of power-electronic circuit devices, a capacitor device and a liquid cooling device. In this case, the multi-part housing consists of three housing elements that are parallelepipedal in their basic form, a centre element and an upper and a lower top element which are arranged on opposing connection surfaces of the centre element, wherein the housing has an inlet connection and an outlet connection for a cooling liquid and at least one upper cooling chamber is formed between the centre element and the upper top element and at least two lower cooling chambers are formed between the centre element and the lower top element, wherein each cooling chamber has at least one cooling surface and wherein the cooling chambers can be flowed through by cooling liquid that enters through the inlet connection and exits at the outlet connection and thus form the liquid cooling device.

### SUMMARY

The invention is based on the object of improving the arrangement of capacitors of a capacitor assembly for a power-electronic system and furthermore of presenting a super-assembly therewith.

This object is achieved according to the invention by a capacitor assembly having a first to fourth individual capacitor each with a first top surface defining a respective normal direction of the individual capacitor and a second top surface opposite said first top surface, wherein the first top surface of the first individual capacitor defines a main direction, in each case first connection elements arranged on the first top surface and in each case second connection elements arranged on the second top surface, wherein the individual capacitors are preferably arranged beside one another in a 2×2 matrix, wherein the normals of the first and second individual capacitor forming a first sub-assembly point in the main direction and wherein the normals of the third and fourth individual capacitor forming a second sub-assembly point opposite the main direction and wherein all the first connection elements are connected to one another by means of a first busbar and wherein all the second connection elements are connected to one another by means of a second busbar.

The term arranged beside one another should be understood in particular to mean that the top surfaces in adjacent individual capacitors form partial surfaces of a plane in mathematical terms and within the scope of technical feasibility.

It may be advantageous if the respectively first connection elements of the individual capacitors of one or both sub-assemblies are arranged in a first surface portion of the first top surface and the respectively second connection elements are arranged in a second surface portion of the second top surface. In this case, it may additionally be advantageous if in each case the first surface portion and second surface portion of an individual capacitor are arranged symmetrically in relation to one another. Furthermore, it may be advantageous if the symmetry is a point symmetry in relation to the centre point of the individual capacitor or a mirror symmetry in relation to an interface of the individual capacitor.

In substantially parallelepipedal individual capacitors, the following are preferred interfaces: the surfaces through the diagonals of the two top surfaces or the plane of symmetry of the parallelpiped parallel to the top surfaces.

In substantially cylindrical individual capacitors, the following are preferred interfaces: the surfaces through the diameters of the two top surfaces or the surfaces through the diagonals of the two top surfaces or the plane of symmetry of the parallelepiped parallel to the top surfaces.

In principle, it may be preferred if the first and second busbar are formed as flat metal mouldings. In this case, it may additionally be preferred if the first and second busbar are arranged above one another over more than 80%, preferably more than 90% and in particular preferably more than 95% of their respective surface and separated by a first insulating device. Furthermore, it may be preferred if a first main portion of the first busbar and a second main portion of the second busbar, immediately adjacent thereto, are arranged above the first and second sub-assembly in the main direction. In this case, it may be preferred if the first and second main portion cover more than 40%, preferably more than 50% and in particular preferably more than 60% of the first and second sub-assembly.

It may also be advantageous if a first intermediate portion of the first busbar and a second intermediate portion of the second busbar are arranged between the first and second sub-assembly and are arranged above one another preferably over more than 80% and in particular preferably more than 90% of their respective surface and separated by a second insulating device.

It may likewise be advantageous if a first intermediate portion of the first busbar and a second intermediate portion of the second busbar are arranged beside the capacitor assembly and are arranged above one another preferably over more than 85% and in particular preferably more than 90% of their respective surface and separated by a second insulating device.

Furthermore, it may be advantageous if the first busbar has an additional first connecting portion and the second busbar has an additional second connecting portion and these connecting portions are designed to simultaneously supply energy to all the individual capacitors.

It may be preferred if the first busbar has an additional first modular portion and the second busbar has an additional second modular portion and these modular portions are designed to simultaneously supply energy to a power semiconductor module made up of the individual capacitors.

Finally, it may be advantageous if respective contact portions of the busbars are connected to the associated connection elements of the individual capacitors in a materially-bonded, preferably welded, manner.

The object is furthermore achieved by a super-assembly made up of two capacitor assemblies, wherein the individual capacitors are preferably arranged in a 2×4 matrix and the respective first busbars degenerate to form a first overall busbar that is preferably formed in one piece and the respective second busbars degenerate to form a second overall busbar that is preferably formed in one piece.

It may be preferred if the overall busbar has exactly one first connecting portion and exactly one second connecting portion. In this case, it may be preferred on the one hand if the overall busbar has exactly one first modular portion and exactly one second modular portion. However, it may also be preferred if the overall busbar has three first modular portions and three second modular portions.

In this case, it may be advantageous in principle if the first and second modular portions are connected, in the correct polarity, to the DC voltage terminals of a power semiconductor module that has three half-bridge circuits in an electrically conductive, preferably materially-bonded, preferably welded, manner.

Of course, the features or groups of features mentioned in the singular in each case may be present multiple times in the capacitor assemblies according to the invention and also in the super-assembly, unless this is explicitly or inherently excluded or contradicts the idea of the invention.

It is understood that the features and configurations of the capacitor assemblies and also of the super-assembly therewith that are mentioned above and hereinafter can be realized individually or in any desired combinations in order to achieve improvements. In particular, the features mentioned above and explained here or hereinafter can be used not only in the specified combinations but also in other non-exclusive combinations or in isolation, without departing from the scope of the present invention.

### BRIEF DESCRIPTION OF THE DRAWINGS

Further explanations of the invention, advantageous details and features are gathered from the following description of the exemplary embodiments of the invention which are depicted schematically in FIGS. 1 to 9 or from respective parts thereof.

FIG. 1 shows a schematic depiction of a power-electronic system with a super-assembly, according to the invention, of two capacitor assemblies according to the invention in an exploded depiction.

FIG. 2 shows a lateral view of this super-assembly according to the invention.

FIG. 3 shows a plan view of the individual capacitors of this super-assembly according to the invention.

FIGS. 4 and 5 show different portions of the busbars of a first capacitor assembly according to the invention.

FIG. 6 shows a second individual capacitor of a capacitor assembly.

FIG. 7 shows a three-dimensional view of a super-assembly, according to the invention, made up of two capacitor assemblies according to the invention.

FIG. 8 shows a sectional view of this super-assembly.

FIG. 9 shows a power-electronic system with a capacitor assembly according to the invention in a three-dimensional view.

### DETAILED DESCRIPTION

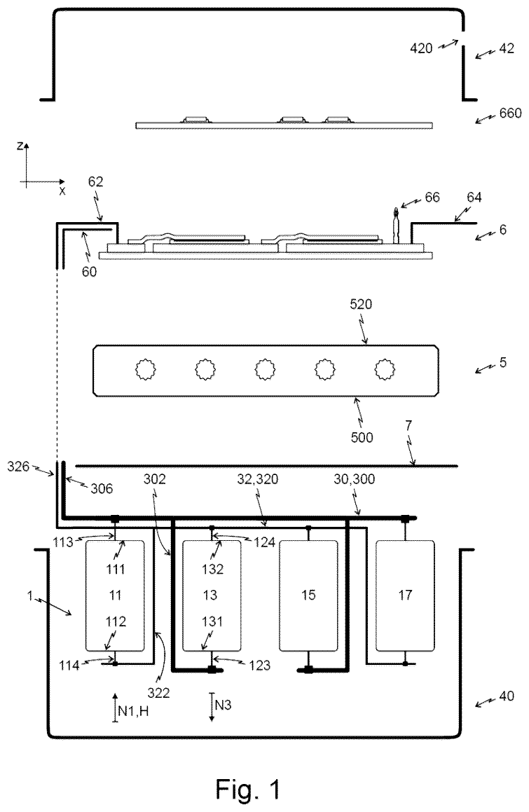

FIG. 1 shows a schematic depiction of a power-electronic system, cf. also FIG. 9, with a super-assembly, according to the invention, of two capacitor assemblies 1 according to the invention in an exploded depiction. This system has, viewed from bottom to top, an arrangement stacked in the main direction H, with a cup-shaped first housing part 40, the super-assembly of two capacitor assemblies 1, a cooling device 5, an insulating layer 7, a power semiconductor module 6, a control switch device 660 and with a second housing part 42.

The first capacitor assembly 1 here has, cf. FIG. 3, a first to fourth individual capacitor 11,12,13,14. Each individual capacitor has a first top surface 111,121,131,141 defining a respective normal direction N1,N2,N3,N4 of the individual capacitor and a second top surface 112, 122,132, 142 opposite said first top surface, wherein the first top surface 111 of the first individual capacitor 11 defines the main direction H. The individual capacitors 11,12,13,14 of the first capacitor assembly in each case have first connection elements 113,123,133,143 arranged on the first top surface and in each case second connection elements 114,124,134,144 arranged on the second top surface. The individual capacitors, cf. FIGS. 3 and 7, are arranged beside one another in a 2×2 matrix in this exemplary embodiment, wherein the normals N1,N2 of the first and second individual capacitor 11,12 forming a first sub-assembly 21 point in the main direction H and wherein the normals N3,N4 of the third and fourth individual capacitor 13,14 forming a second sub-assembly 22 point opposite the main direction H. All the first connection elements 113,123,133,143 are connected to one another by means of a first busbar 30, and all the second connection elements 114,124,134,144 are connected to one another by means of a second busbar 32.

A second capacitor assembly of the super-assembly is also depicted. Details regarding the arrangement thereof can be gathered from FIGS. 3, 7 and 8.

The cooling device 5 has a first cooling contact surface 500 that is in direct thermal contact with the capacitor device 1. In this case, the thermal contact is, without limiting generality, direct, i.e. separated only by the insulating layer 7, with a first and second main portion 300,320, as part of a first and second busbar 30,32. The individual capacitors 11,13,15,17 of the super-assembly are then in indirect thermal contact with the first cooling contact surface 500, again without limiting generality, via the main portions 300,320.

A second cooling contact surface 520 of the cooling device 5, opposite to the first, is in direct thermal contact with the power semiconductor module 6. Said power semiconductor module is arranged directly on the second cooling contact surface 502. As is customary in the art, a heat-conducting paste can additionally be arranged between the power semiconductor module 6 and the second cooling contact surface 520.

The power semiconductor module 6 has DC voltage load terminal elements 60,62 which are electrically conductively connected, in the correct polarity, to associated modular portions 306,326 of the first and second busbar 30,32.

The power semiconductor module 6 is connected to the control switch device 660 by means of auxiliary contact elements 66. Said control switch device 660 is formed as a printed circuit board, which is customary in the art, and is used to activate the power semiconductor module 6 and receives the associated control signals via a plug connection, not depicted, with a higher-level controller in particular of a vehicle controller, if the power-electronic system is part of a drive train of an electric vehicle.

A second sub-housing 42, which interacts with the first sub-housing 40, covers the cooling device 5, the power semiconductor module 6 and the control switch device 660. Said second sub-housing 42 has bushings 420 for AC voltage load terminal elements 64 and also the plug connections, not depicted, for control signals.

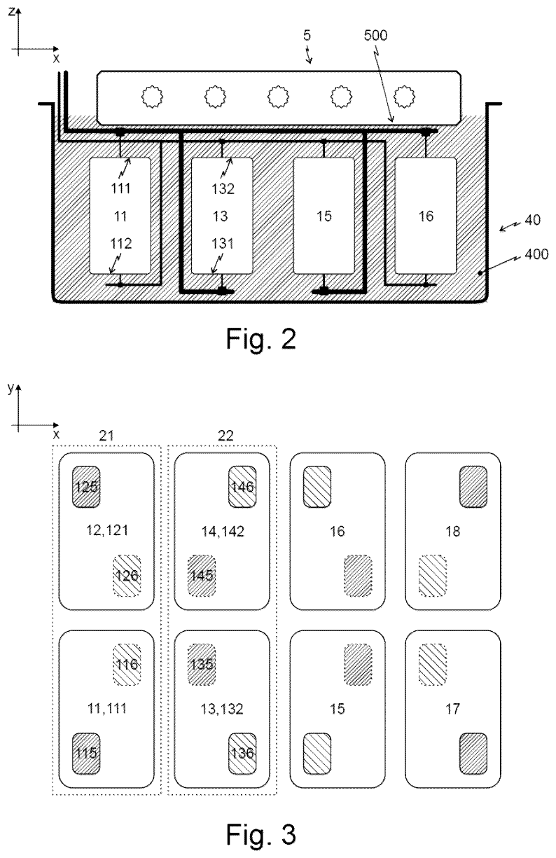

FIG. 2 shows a lateral view of this super-assembly according to the invention arranged in the first sub-housing 40. Said first sub-housing is filled with an insulating compound 400 that covers the entire super-assembly and also the main portions 300,320 of the busbar 30,32. In addition, a portion of the cooling device 5 facing the super-assembly is also embedded in the insulating compound 400.

FIG. 3 shows a plan view of the individual capacitors of this super-assembly according to the invention. Said super-assembly is formed of two capacitor assemblies, wherein the individual capacitors 11,12,13,14 of the first capacitor assembly are arranged beside one another in a 2×2 matrix. Alternatively, a 2×M arrangement, with M being <2, preferably M being even-numbered, would also be conceivable, wherein the capacitors with ordinal numbers greater than 2 would be arranged in the y direction. A further alternative is a 2×1 arrangement of a first and third individual capacitor, which then each form a sub-assembly with only one capacitor. Essential characteristics of the exemplary embodiments are then also applicable to this configuration.

The individual capacitors 15,16,17,18 of the second capacitor assembly are arranged beside one another also in a 2×2 matrix, similarly to the first capacitor assembly.

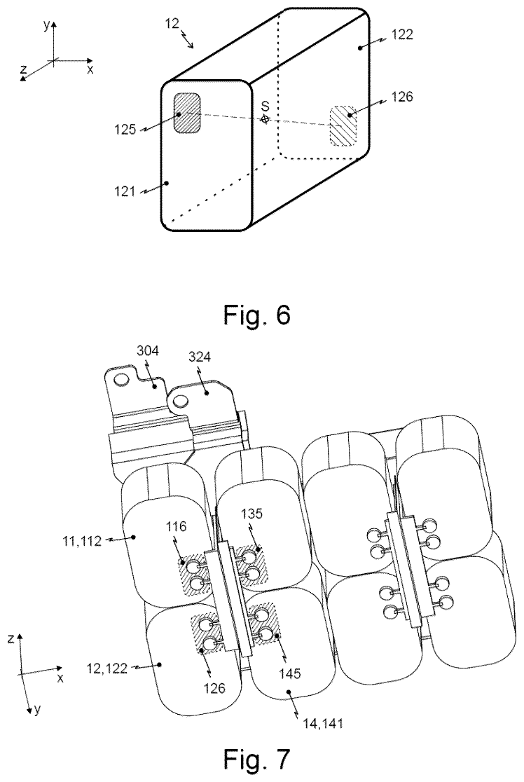

The respectively first connection elements 113,123,133,143 of the individual capacitors 11,12,13,14 of both sub-assemblies 21,22 are arranged in a first surface portion 115,125,135,145 of the first top surface 111,121,131,141 and the respectively second connection elements 114,124,134,144 are arranged in a second surface portion 116,126,136,146 of the second top surface 112,122,132, 142. In this exemplary embodiment, the respective surface portions are arranged in corner regions or, from a different perspective, in only one quadrant of a virtual Cartesian coordinate system with an origin in the centre of the respective top surface. Furthermore, in each case the first surface portion 115,125,135,145 and second surface portion 116,126,136,146 of the respective individual capacitors 11,12,13,14 are arranged symmetrically in relation to one another, cf. also FIG. 6. The symmetry present here is a point symmetry in relation to the centre point S of the respective individual capacitor 11,12,13,14. Furthermore, the respective surface portions lie on the upper side, i.e. the first surface portions 115,125 of the first and second individual capacitor 11,12 and the second surface portions 136,146 of the third and fourth individual capacitor 13,14, of the respective capacitor arrangement point-symmetrically in relation to their common centre point, or virtual point of gravity S. The same applies to the respective surface portions on the lower side, i.e. the second surface portions 116,126 of the first and second individual capacitor 11,12 and the first surface portions 135,145 of the third and fourth individual capacitor 13,14.

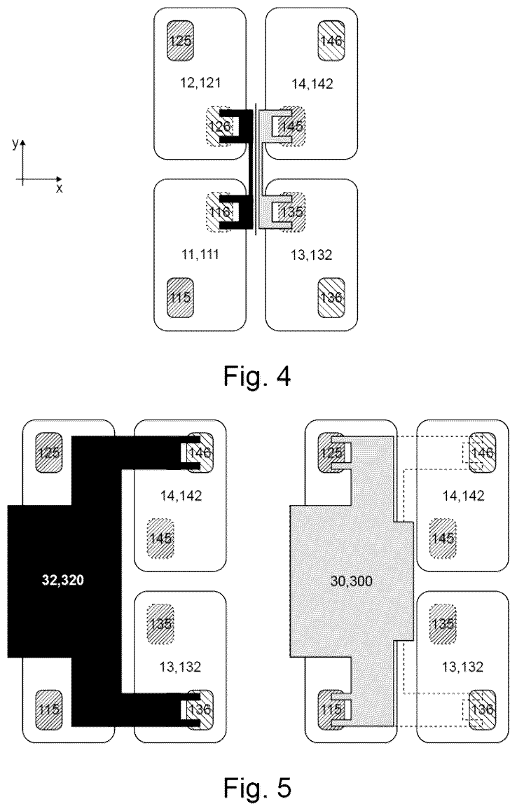

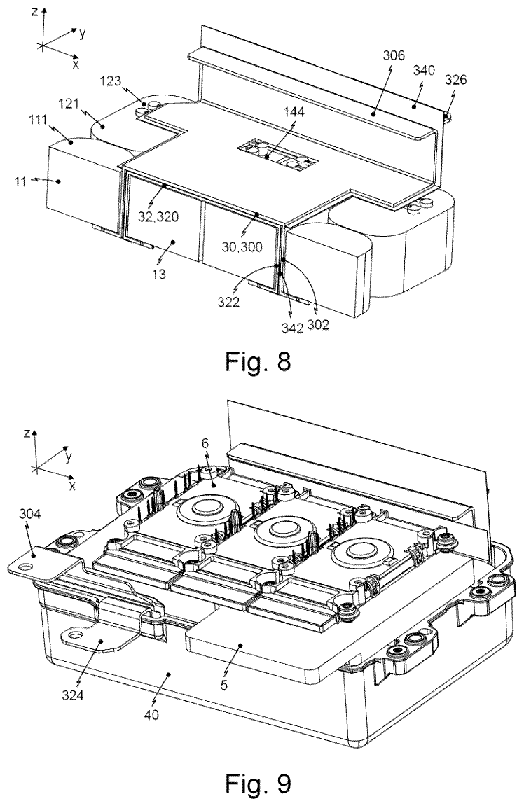

FIGS. 4 and 5 show different portions of the busbars, which are each formed as flat metal mouldings as is customary in the art, on a first capacitor assembly according to the invention. FIG. 4, cf. also FIG. 7, shows the surface portions in which the connection elements, not depicted, of the respective individual capacitors are arranged on the lower side of the first capacitor assembly and the associated contact portions of the first and second busbar. These adjoin, cf. also FIG. 8, respective intermediate portions 302,322 of the first and second busbar 30,32, which are arranged between the first and second sub-assembly 21,22, starting from the main portions 300,320. Of course, the respective intermediate portions, like all the portions of the busbars, are necessarily arranged electrically insulated from one another by means of a second insulating device 342, see FIG. 8. Said second insulating device is formed as an electrically insulating foil, by way of example.

FIG. 5, cf. also FIG. 8, shows the surface portions in which the connection elements, not depicted, of the respective individual capacitors are arranged on the upper side of the first capacitor assembly and the associated connection elements of the first and second busbar are in direct connection to the respective main portions. In this case, the first main portion 300 of the first busbar 30 and a second main portion 320 of the second busbar 32, immediately adjacent thereto, are arranged above, but not completely covering, the first and second sub-assembly 21,22 in the main direction H. The first main portion 300 covers more than 60% of the second main portion 320 here.

FIG. 6 shows a second individual capacitor of a capacitor assembly and the position of the point of symmetry, mentioned in relation to FIG. 3, of the first surface portion 125 on the first top surface in relation to the second surface portion 126 on the second top surface, in a substantially parallelpipedal configuration of the individual capacitor.

FIG. 7 shows a three-dimensional view of a super-assembly, according to the invention, made up of two capacitor assemblies according to the invention, cf. FIG. 3. The position of the second surface portions 116,126 of the first and second individual capacitor 11,12 and also the position of the first surface portions 135,145 of the third and fourth individual capacitor 13,14 of the first capacitor assembly are depicted here. The connection elements of the first and second busbar 30,32 to the connection elements of the individual capacitors in these surface portions are furthermore depicted.

An additional first connecting portion 304 of the first busbar 30 and an additional second connecting portion 324 of the second busbar 32 are furthermore depicted. These connecting portions 304,324 in principle are designed and intended to supply energy simultaneously to individual capacitors of the first capacitor assembly here and even to both capacitor assemblies of the super-assembly. By way of example, in electrically powered vehicles, said energy is supplied from a battery or a fuel cell.

Within the context of this exemplary embodiment, the respective contact portions of the busbars 30,32 are connected to the associated connection elements 113,114,123, 124,133, 134,143, 144 of the individual capacitors 11,12,13,14 in a materially-bonded, preferably welded, manner.

FIG. 8 shows a sectional view of this super-assembly. The first and second busbar 30,32 are depicted here. The main portions of these two busbars are arranged above one another over more than 90% of their respective surface and only separated by a first insulating device 340 and in the main direction H above the first and second sub-assembly 21,22 and each consist of a metal moulding, more precisely a metal sheet, manufactured in a punching and bending process.

A first intermediate portion 302 of the first busbar 30 and a second intermediate portion 322 of the second busbar 32 are arranged between the first and second sub-assembly 21,22, cf. FIG. 3, and preferably arranged above one another over more than 90% of their respective surface and separated by a second insulating device 342, which is formed in one piece with the first insulating device 340 in this embodiment.

Furthermore, the first busbar 30 has an additional first modular portion 306 and the second busbar 32 has an additional second modular portion 326.

In addition, here, like in FIG. 1 by way of example, the respective busbar connects all the individual capacitors 11,12,13,14, 15, 16, 17,18 of both capacitor assemblies, which are arranged in a 2×4 matrix here, to one another. Therefore, the respective busbars 30,32 of the individual capacitor assemblies degenerate to form a respective overall busbar formed in one piece.

FIG. 9 shows a power-electronic system with one, here even two, as depicted in FIGS. 7 and 8, capacitor assemblies according to the invention in a three-dimensional view. The capacitor assemblies, i.e. the super-assembly, are/is arranged in a cup-shaped first sub-housing. A liquid cooling device is arranged above the super-assembly in the main direction and three power semiconductor modules are arranged on said liquid cooling device, purely by way of example.

Here, the two busbars or the overall busbar have/has exactly one first modular portion 306 and exactly one second modular portion 326. These two modular portions are used to simultaneously supply energy to all three power semiconductor modules 6 made up of the individual capacitors.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A capacitor assembly having a first to fourth individual capacitor each with a first top surface defining a respective normal direction (N1,N2,N3,N4) of the individual capacitor and a second top surface opposite said first top surface, wherein the first top surface of the first individual capacitor defines a main direction H, in each case first connection elements arranged on the first top surface and in each case second connection elements arranged on the second top surface, wherein the individual capacitors are preferably arranged beside one another in a 2×2 matrix, wherein the normals N1,N2 of the first and second individual capacitor forming a first sub-assembly point in the main direction (H) and wherein the normals (N3,N4) of the third and fourth individual capacitor forming a second sub-assembly point opposite the main direction (H) and wherein all the first connection elements are connected to one another by means of a first busbar and wherein all the second connection elements are connected to one another by means of a second busbar.

2. The capacitor assembly according to claim 1, wherein
the respectively first connection elements of the individual capacitors of one or both sub-assemblies are arranged in a first surface portion of the first top surface and the respectively second connection elements are arranged in a second surface portion of the second top surface.

3. The capacitor assembly according to claim 2, wherein
in each case the first surface portion and second surface portion of an individual capacitor are arranged symmetrically in relation to one another.

4. The capacitor assembly according to claim 3, wherein
the symmetry is a point symmetry in relation to the centre point(S) of the individual capacitor or a mirror symmetry in relation to an interface of the individual capacitor.

5. The capacitor assembly according to claim 1, wherein
the first and second busbar are formed as flat metal mouldings.

6. The capacitor assembly according to claim 5, wherein
the first and second busbar are arranged above one another over more than 80%, preferably more than 90% and in particular preferably more than 95% of their respective surface and separated by a first insulating device.

7. The capacitor assembly according to claim 5, wherein
a first main portion of the first busbar and a second main portion of the second busbar, immediately adjacent thereto, are arranged above the first and second sub-assembly in the main direction H.

8. The capacitor assembly according to claim 7, wherein
the first and second main portion cover more than 40%, preferably more than 50% and in particular preferably more than 60% of the first and second sub-assembly.

9. The capacitor assembly according to claim 1, wherein
a first intermediate portion of the first busbar and a second intermediate portion of the second busbar are arranged between the first and second sub-assembly and are arranged above one another preferably over more than 80% and in particular preferably more than 90% of their respective surface and separated by a second insulating device.

10. The capacitor assembly according to claim 1, wherein
a first intermediate portion of the first busbar and a second intermediate portion of the second busbar are arranged beside the capacitor assembly and are arranged above one another preferably over more than 85% and in particular preferably more than 90% of their respective surface and separated by a second insulating device.

11. The capacitor assembly according to claim 1, wherein
the first busbar has an additional first connecting portion and the second busbar has an additional second connecting portion and these connecting portions are designed to simultaneously supply energy to all the individual capacitors.

12. The capacitor assembly according to claim 1, wherein
the first busbar has an additional first modular portion and the second busbar has an additional second modular portion and these modular portions are designed to simultaneously supply energy to a power semiconductor module made up of the individual capacitors.

13. The capacitor assembly according to claim 1, wherein
respective contact portions of the busbars are connected to the associated connection elements of the individual capacitors in a materially-bonded, preferably welded, manner.

14. A super-assembly made up of two capacitor assemblies, wherein the individual capacitors are preferably arranged in a 2×4 matrix and the respective first busbars degenerate to form a first overall busbar that is preferably formed in one piece and the respective second busbars degenerate to form a second overall busbar that is preferably formed in one piece.

15. The super-assembly according to claim 14, wherein
the overall busbar has exactly one first connecting portion and exactly one second connecting portion.

16. The super-assembly according to claim 14, wherein
the overall busbar has exactly one first modular portion and exactly one second modular portion.

17. The super-assembly according to claim 14, wherein
the overall busbar has three first modular portions and three second modular portions.

18. The super-assembly according to claim 16, wherein
the first and second modular portions are connected, in the correct polarity, to the DC voltage terminals of a power semiconductor module that has three half-bridge circuits in an electrically conductive, preferably materially-bonded, preferably welded, manner.
